(19) United States
(12) Patent Application Publication
(10) Pub. No.: US 2003/0124316 A1
(43) Pub. Date: Jul. 3, 2003

(54) Repulpable, water repellant paperboard

(76) Inventors: Yan C. Huang, Campbell Hall, NY (US); Warren G. Mumford, Cornwall-On-Hudson, NY (US); David Lee Ramsdell, Marshallville, OH (US); Edwin Darrell Ford, Wooster, OH (US); James Edward Keltz, Orrville, OH (US); Danny Kaye Casey, Wooster, OH (US)

Correspondence Address: OSTRAGER CHONG & FLAHERTY LLP, 825 Third Avenue, New York, NY, 10022-7519, US

(21) Appl. No.: 10/251,303

(22) Filed: Sep. 20, 2002

Related U.S. Application Data
(60) Provisional application No. 60/323,671, filed on Sep. 20, 2001.
(60) Provisional application No. 60/400,033, filed on Jul. 31, 2002.

(51) Int. Cl. B32B 3/30

(52) U.S. Cl. 428/182

(57) ABSTRACT

A repulpable sheet of moisture resistant corrugated board having a first and second linerboard sheets with a fluted or corrugated sheet of corrugating medium therebetween. The corrugating medium is coated with a moisture resistant coating, which does not detract from the repulpability of the corrugated board, and first and/or second linerboard sheets may be coated with moisture resistant coatings, which do not detract from the repulpability of the corrugated board.

### FIELD OF THE INVENTION

The present invention relates corrugated shipping container that is coated with a wax-free composition. More particularly, the invention relates to a water-repellant corrugated boxboard, which is also repulpable, wherein the medium is treated with a polymeric material and/or sizing agent.

### BACKGROUND OF THE INVENTION

Corrugated paperboard comprises an assembly of a pair of spaced apart linerboards with a corrugated medium sandwiched between and adhered thereto. When used in making corrugated packaging, the open edge of the paperboard container is exposed to the ambient conditions and becomes the frontline for water or water-like liquids and humidity, which diminishes the performance of the paperboard container.

Perishables, such as chicken, meat, fishery products, fruits and vegetables are typically shipped (either ice-packed or under modified atmosphere packaging known as MAP) in boxes or containers formed of corrugated paperboard which has been coated with a water repellant material. The requirements of the goods being shipped determine the amount and placement of the coatings. Natural and synthetic waxes are the conventional and most widely used coating or chemical treatment material for water repellency along with some synthetic organic compounds such as ethylene vinyl acetate. However, once used, such coated shipping boxes are difficult to recycle. Since it has generally not been economical to repulp wax-coated board, used shipping boxes and the like made from water-repellant linerboard have typically been dumped into a landfill or incinerated rather than recycled. Not only is this practice wasteful, it is also environmentally undesirable and a contributing factor to the growing solid waste disposal problem.

Wax-free coatings have also been used in the manufacture of corrugated paperboard. Examples of wax-free coating used in manufacture of corrugated paperboard are: U.S. Pat. No. 2,392,972 to Cheyney discloses surfacing of paper with a coating of vinylidene chloride-vinyl chloride copolymers; U.S. Pat. No. 3,476,587 to Demol et al. discloses compositions comprising two vinylidene chloride copolymers; U.S. Pat. No. 3,306,766 to Hathaway et al. discloses a paper based sheet, having the exposed surface thereof coated with a haloethylene polymer resin and an intermediate flexible foundation coating of extruded ethylene-lower alkyl acrylate copolymer resin; and U.S. Pat. No. 5,989,724 to Wittosch et al. discloses paper stock coated with polymeric dispersion, such as an acrylic polymers, acrylic copolymers, polyvinylacetate, polyvinyl chloride, and polyvinylidene chloride.

The references mentioned above disclose corrugated paperboard coated with wax or corrugated paperboard coated with wax-free coatings wherein only the linerboard is coated leaving the corrugated medium subject to the environmental decay. Thus, it would be desirable to find an alternative for conventional wax coatings wherein the linerboard and the medium are coated with a wax-free, water-resistant composition that has comparable or better moisture barrier properties, and also has the added benefit of repulpability and recyclability. The present invention solves the problem by using wax-free coated corrugated paperboard with a first linerboard, a corrugated medium, and a second linerboard that is equal or better than wax-coated paperboard in performance in modified atmosphere packaging and ice pack, and which is repulpable and recycable.

### BRIEF DESCRIPTION OF THE DRAWINGS

FIG. 1 shows a fragmentary view, in cross section, of a sheet of corrugated board.

FIG. 2 shows a cross section of a sheet of corrugated board wherein the first linerboard is coated on the outer surface and the second linerboard is uncoated.

FIG. 3 shows a cross section of a sheet of corrugated board wherein the second linerboard is coated on the outer surface and the first linerboard is uncoated.

FIG. 4 shows a cross section of a sheet of corrugated board wherein the second linerboard is coated on the inner surface and on the outer surface and the first linerboard is uncoated.

FIG. 5 shows a cross section of a sheet of corrugated board wherein the first linerboard is coated on the outer surface and the second linerboard is coated on the inner surface and the outer surface.

FIG. 6 shows a cross section of a sheet of corrugated board wherein the first linerboard is coated on the inner surface and the second linerboard is coated on the inner surface and the outer surface.

FIG. 7 shows a cross section of a sheet of corrugated board wherein the first linerboard is coated on the outer surface and the second linerboard is coated on the outer surface.

FIG. 8 shows a cross section of a sheet of corrugated board wherein the first linerboard is coated on the outer surface and the inner surface and the second linerboard is coated on the outer surface and the inner surface.

FIG. 9 shows a cross section of a sheet of corrugated board wherein neither the first linerboard nor the second linerboard is coated.

FIG. 10 shows a cross section of a sheet of corrugated board wherein the first linerboard is coated on the outer surface and the inner surface and the second linerboard is uncoated.

FIG. 11 shows a cross section of a sheet of corrugated board wherein the first linerboard is coated on the outer surface and the inner surface and the second linerboard is coated on the inner surface.

FIG. 12 shows a cross section of a sheet of corrugated board wherein the first linerboard is coated on the outer surface and the inner surface and the second linerboard is coated on the outer surface.

FIG. 13 is a perspective view of the lid blank corrugated paperboard sheet prior to folding.

FIG. 14 is a perspective view of the box blank corrugated paperboard sheet prior to folding.

### SUMMARY OF THE INVENTION

Having regard to the foregoing and other objects and advantages, the present invention is directed to a water repellant paperboard that exhibits improved properties, particularly repulpability. The paperboard sheet is especially well-suited for use in the manufacture of corrugated boxes for shipping and storing food, particularly perishable foods such as ice-packed chicken, meat, fishery products, fruits and vegetables. The invention is useful in demanding applications that require a combination of high water repellency, high wet strength and durability under wet conditions for use in food containers.

Accordingly, it is an object of the present invention to provide a water-repellant paperboard wherein the corrugated medium is treated so as to achieve a water/humidity resistant boxboard that is repulpable.

Another object of the present invention to provide a water-repellant paperboard wherein the corrugated medium is treated with a polymeric agent so as to achieve a water/humidity resistant boxboard that is repulpable.

Another object of the present invention to provide a water-repellant paperboard wherein the corrugated medium is treated with a sizing agent so as to achieve a water/humidity resistant boxboard that is repulpable.

Another object of the present invention to provide a water-repellant paperboard wherein the corrugated medium is treated with a polymeric agent and a sizing agent so as to achieve a water/humidity resistant boxboard that is repulpable.

Another object of the present invention to provide a water-repellant paperboard wherein at least one side of the outer and/or inner surface of the first and/or second linerboard is coated and wherein the corrugated medium is treated so as to achieve a water/humidity resistant boxboard that is repulpable.

Another object of the present invention to provide a water-repellant paperboard wherein at least one side of the outer and/or inner surface of the first and/or second linerboards are coated with a polymeric material.

Another object of the present invention is to provide a water-repellant paperboard of the character described which is economical to produce, to repulp.

A further object of the present invention is to provide a water-repellant corrugated paperboard especially well suited for use in the construction of boxboards for shipment of perishable foods.

A further object of the present invention is to provide for the construction of boxboards for shipment of perishable foods wherein the box or blank panels is treated with a hot melt glue.

### DETAILED DESCRIPTION OF THE INVENTION

Certain terms are employed herein to identify characteristics of the coating composition, the coated paperboard liner and the corrugated paperboard. These terms are believed to be clear in the context of the invention, to a person skilled in the art but are further elaborated here.

The terms “water repellent” and “water resistant” refer to the tendency of the coating to repel, block or, in any event, not transmit or absorb any significant quantity of liquid water in normal use. In other words, these terms identify a liquid water-blocking property of the coating sufficient for packing intended for perishable frozen foods.

The term “grease resistant” refers to the character of the coating in repelling, blocking or, in any event, not transmitting or absorbing any significant quantity of grease or oil.

The term “water vapor permeable” refers to the character of the coating in permitting passage therethrough of water in vapor form.

The term “water vapor impermeable” refers to the character of the corrugating medium in not permitting passage therethrough of water in vapor form.

The term “repulpable” refers to the character of the coated paperboard liner and the corrugated paperboard, whereby the paper fibre component of the paperboard liner and the corrugated paperboard can be readily recovered as a pulp suitable for use in paper product manufacture, the coating composition of the invention not presenting any significant obstacle to such pulp recovery. The term is to be viewed in the context that the conventional wax coated paperboard liners employed in corrugated paperboard packages for perishable frozen foods, are considered essentially non-repulpable based on a number of factors including the difficulty in separating the wax coated paper fibers and the contamination of any fibre pulp produced with wax particles which form stickies rendering the pulp unsuitable for paper manufacture.

As such the term “repulpable” contemplates absence or substantial absence of wax or comparable materials that would render the paperboard liner and corrugated paperboard non-repulpable.

In the present invention the corrugated paperboard has the necessary characteristics for packaging of perishable frozen foods, including water-repellency, grease resistance and water vapor impermeability.

Corrugated paperboard comprises an assembly of a pair of spaced apart linerboards with a corrugated medium sandwiched between and adhered thereto. The treatment of the corrugated medium and the employment and placement of the coating of the present invention on at least one side of the inner and/or outer surface of the first and/or second linerboards permits considerable variation in the manufacture of the corrugated paperboard, and results in a water-resistant boxboard that is also recyclable. Thus, the paperboard of the present invention has particular application in packaging such as for perishable frozen foods in which the paperboard is required to be water resistant or repellent and grease resistant.

The paperboard may be manufactured by papermaking process such as paper machine wet-end addition, size press addition, water base, steam shower calender stock, dryer cans. The corrugated paperboard may be assembled employing pre-coated paperboard liners which are water vapor permeable so that post-coating of the manufactured corrugated paperboard is not required, thereby considerably simplifying the manufacturing process of the corrugated paperboard. The linerboard and corrugated medium constructions is of single, double or any other multiple flute boxboards. The shape and dimensions of the container made in accordance with the present invention may be of any design. There is no basis weight restriction for the linerboards. That is, the linerboards may be of both the single facer and the double backer type.

The corrugated medium may be of 33, 45 lb/1000 ft2 or other basis weight, and the corrugation may be B-, C-, E-, F- or any other available flutes. The corrugated medium is treated with a wax free polymeric agent and/or sizing agent(s). The coating composition may additionally comprise inert particulate filler and/or starches.

The polymer agent may be applied on a paper machine at the size press. A solution of the mentioned polymers at temperature between 70 and 160° F. can be pumped directly to the size press and then applied onto paper by the size press or added and mixed in a size-press starch solution. The size press starch solution, either by itself or with the addition of the polymers should be kept at 140 to 160° F. The addition level of the polymers may vary from 10 to 150 lbs/ton of paper to achieve various degree of water/humidity resistance. Internal sizing agents may be added directed into the papermaking furnish at the wet end of the paper machine in the range from 3 to 12 lbs/ton of paper.

The inner and/or outer surface of the first and/or second linerboard may be coated with a polymeric material. The coating composition may additionally comprise inert particulate filler and/or starches. Application of the coating to the linerboard is achieved by using a rod coating station (often noted as off-line coating) with multiple bumps (coated once, twice, three times, etc., two bumps being the most common) at a total coated weight of 0.25 to 2.5 lbs/msf (one thousand square feet). A rod coater is most commonly used standard equipment. The material is dried after each bump (coating), and before any subsequent coating layer is applied. Typically the lower coating weights will be employed for product that demand less humidity resistance

In the case in which the linerboard is to be used in the manufacture of corrugated containers for shipping chicken and ice-packed perishables, which is a use for which the invention is particularly well-suited, the fibrous web of the linerboards may desirably comprise a high wet-strength paperboard produced by any of the known techniques. Generally speaking, wet-strength paper is a paper that retains 15 percent or more of its dry strength when thoroughly wetted with water.

A number of available paperboard products have wet strength in the range of 30 to 40 percent of the dry strength. Wet strength may be conferred by addition of wet-strength resins such as derivatives of urea-formaldehyde, melamine-formaldehyde and polyamide-epichlorohydrin added to the furnish stock after the last refiner in the papermaking machine. The benefits of the present invention are important in facilitating the repulping of wet strength paper that has generally been considered more difficult to repulp due to the presence of wet-strength resins. That is, although wet-strength paper is a material of choice for corrugated containers for shipping perishables, due to the presence of water, the modification of the linerboard, which confers wet strength coupled with the presence of wax surface-coatings, has compounded the difficulties in repulping this material. The surface coating of the present invention provides improved repulpability of such composites and, thus, lessens the repulping problems inherent in the use of wet strength wax-coated board.

For packaging applications such as meat, fruit, and vegetables, non-wet strength linerboard substrates such as 57 lb PL (pineliner) or 69 K (Kraft) are coated with aqueous based barrier coating formulations. For shipping meat, the inner of the corrugated box is preferably coated for obtaining properties such as water/grease resistance and release properties at freezer conditions at 15 degree-30 degree F. In the cases of boxes for fruit and vegetables, both the inner and outer surfaces of the corrugated boxes are preferably coated to provide water resistance sufficient to withstand the conditions encountered in the field, processing plants, storage, and distribution in cooler environment at 35 degree-45 degree F.

Perishables and ice loaded within the container with the coated surface and treated corrugated medium of the present invention restricts penetration of water and other fluids such as blood or juices into the container. Likewise, the water repellant surfaces and treated corrugated medium limit entry of water and other fluids into the container to avoid contamination of the contents. The provision of water repellant surfaces on either or both the interior and exterior and the water repellant corrugated medium of the container thus provides a container especially well suited for use where flow of fluid into and out of the container is to be avoided.

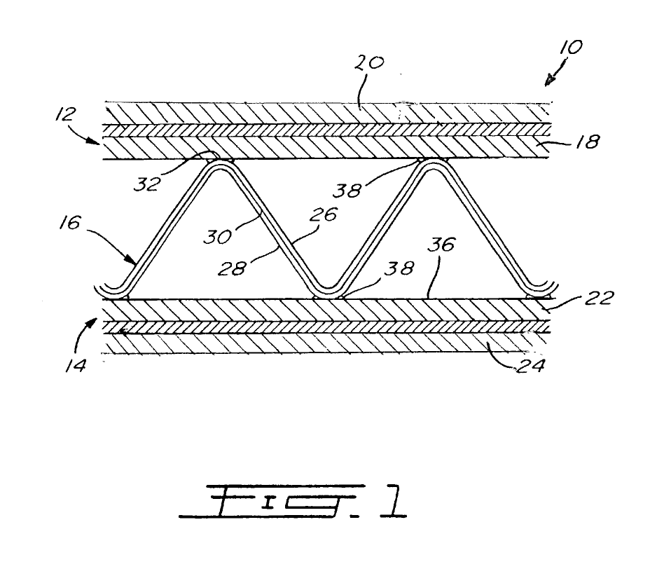

With reference to the drawings in which like reference characters designate like or similar parts throughout the several views, FIG. 1, shows a cross-section of a portion of a corrugated paperboard 10 of the invention comprises a first linerboard 12 and a second linerboard 14 with corrugated medium 16 therebetween. The first linerboard 12 has an inner surface 18 adjacent to, facing and adhered to the first side of the corrugated medium and outer surface 20 opposite said inner surface. The second linerboard 14 has an inner surface 22 adjacent to, facing and adhered to the first side of the fluting and outer surface 24 opposite said inner surface. The first linerboard 12 may be coated on the outer surface 20 and/or the inner surface 18; and the second linerboard 14 may be coated on the outer surface 24 and/or the inner surface 22. Thus, none or at least one of the outer surfaces or inner surfaces of the first or second linerboard may be coated. The coating is preferably a polymeric material. The coating may be provided by applying through use of any suitable coating process, such as a rod and/or air knife coater, to the surfaces of linerboards 12 and 14. The corrugated medium 16 may be treated 30 and/or coated 26 and 28 with a polymeric material and/or sizing agent so that it is water/humidity resistant. The flute tips 16 a of corrugated medium 16, are adhered to the inner faces 18 of linerboards 12 and 14 respectively.

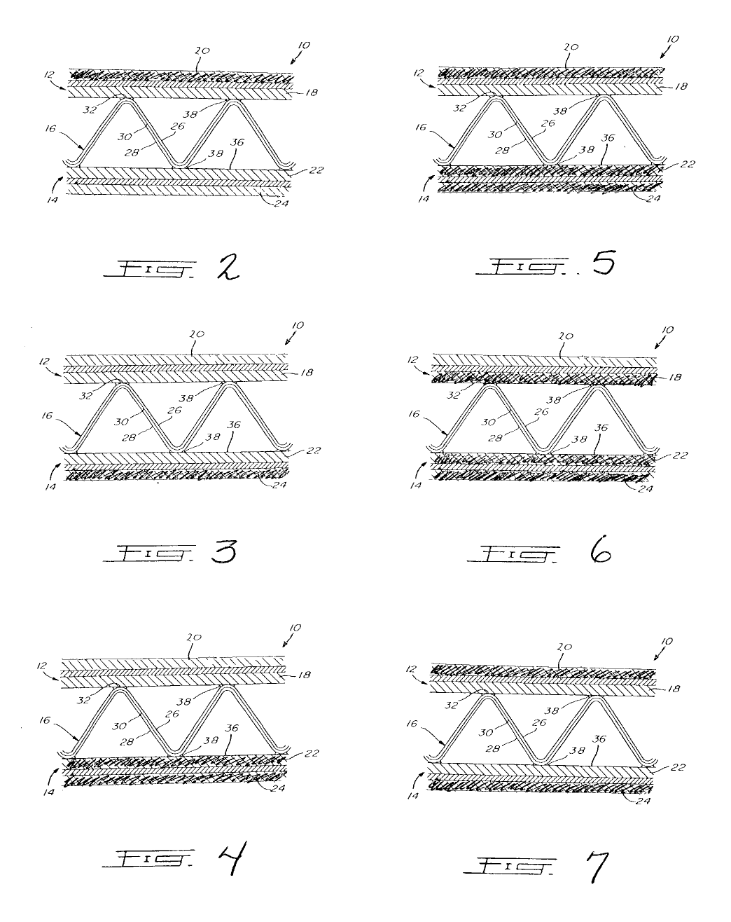

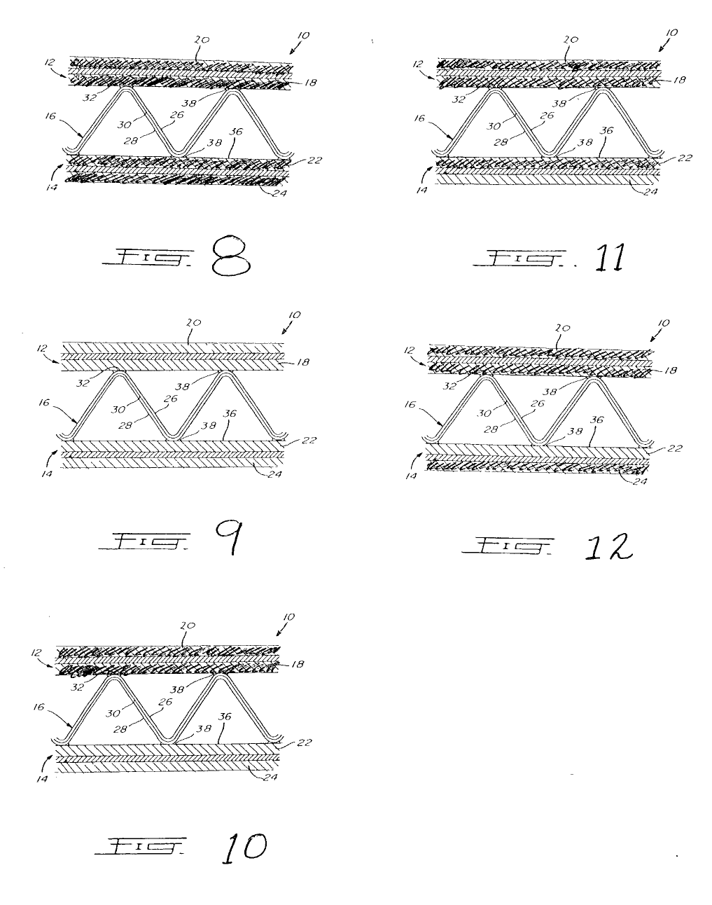

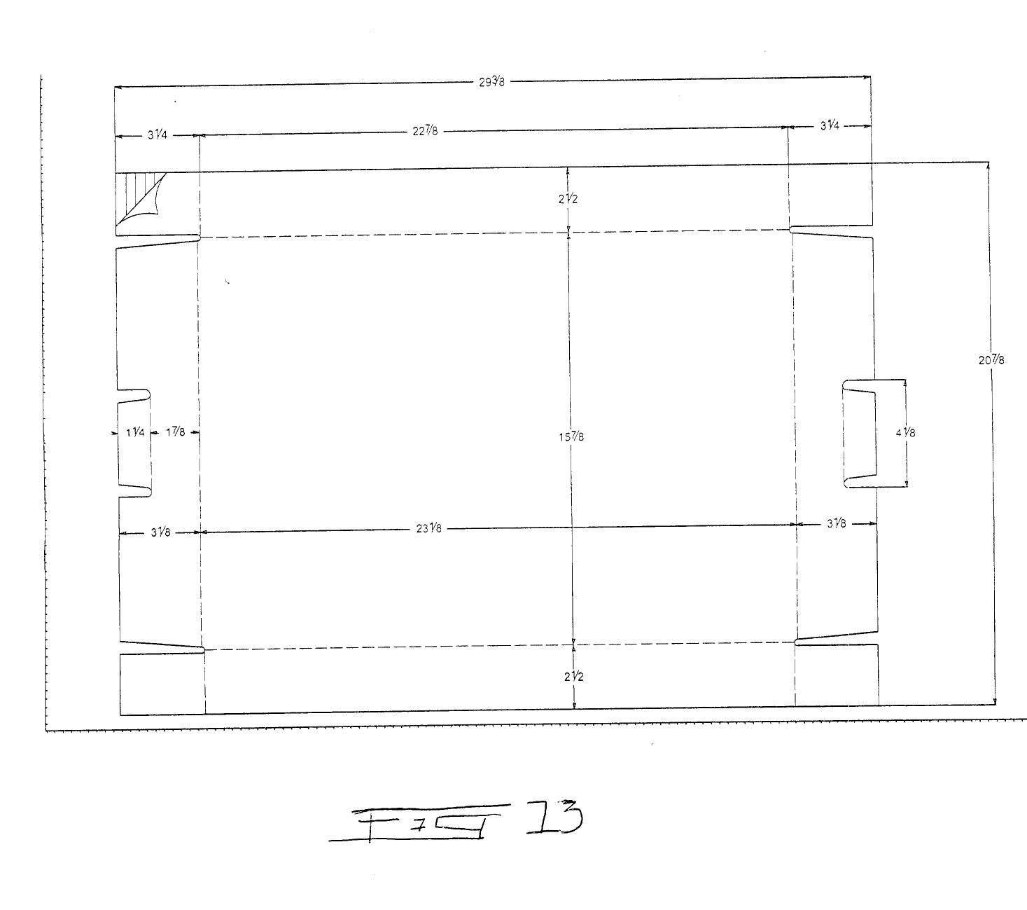

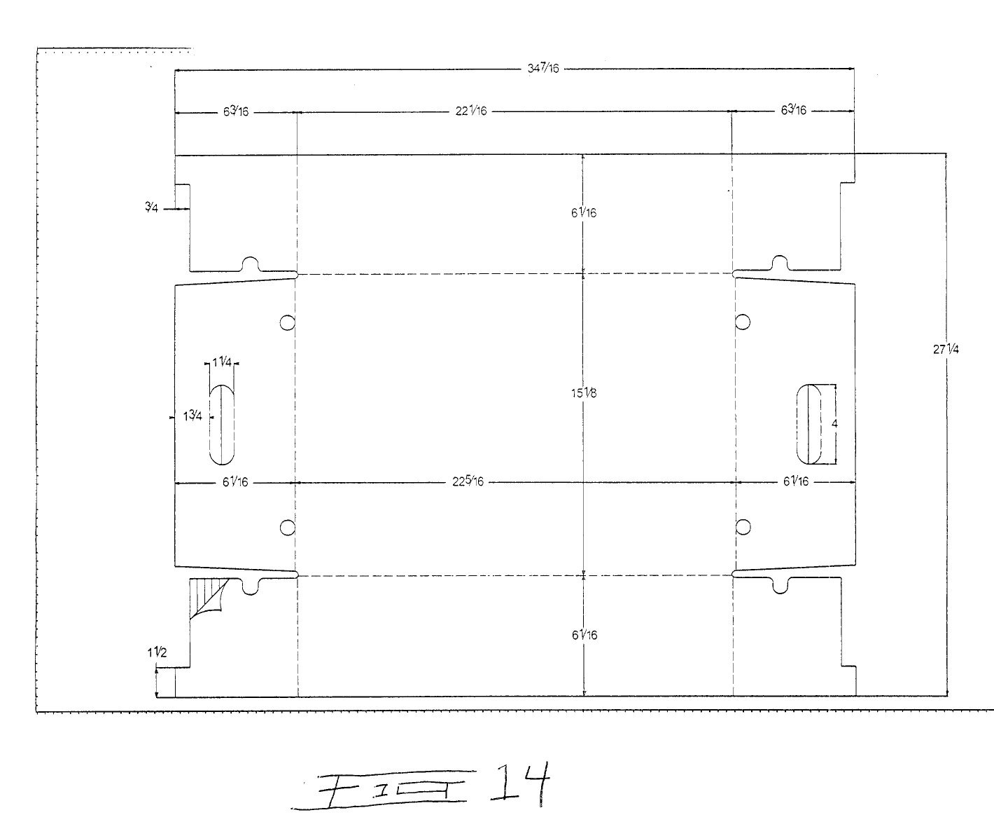

FIGS. 2-12 show various embodiments of the present invention. In FIG. 2, the first linerboard 12 is coated on the outer surface 20, and the second linerboard 14 is uncoated. In FIG. 3, the second linerboard 14 is coated on the outer surface 24, and the first linerboard 12 is uncoated. In FIG. 4, the second linerboard 14 is coated on the inner surface 22 and on the outer surface 24, and the first linerboard 12 is uncoated. In FIG. 5, the first linerboard 12 is coated on the outer surface 20 and the second linerboard is coated on the inner surface 22 and the outer surface 24. In FIG. 6, the first linerboard 12 is coated on the inner surface 18 and the second linerboard 14 is coated on the inner surface 22 and the outer surface 24. In FIG. 7, the first linerboard 12 is coated on the outer surface 20 and the second linerboard 14 is coated on the outer surface 24. In FIG. 8, the first linerboard 12 is coated on the outer surface 20 and the inner surface 18, and the second linerboard 14 is coated on the outer surface 24 and the inner surface 22. In FIG. 9 none of the surfaces of the first linerboard 12 or the second linerboard 14 is coated. In FIG. 10, the first linerboard 12 is coated on the outer surface 20 and the inner surface 18, and the second linerboard 14 is uncoated. In FIG. 11, the first linerboard 12 is coated on the outer surface 20 and the inner surface 18, and the second linerboard 14 is coated on the inner surface 22. In FIG. 12, the first linerboard 12 is coated on the outer surface 20 and the inner surface 18, and the second linerboard 14 is coated on the outer surface 24.

With further reference to FIGS. 13 and 14, the container may be erected from a single blank shown in FIGS. 13 and 14 produced from the corrugated board as shown in FIG. 1 by folding along score lines and/or gluing the blank in a manner well known in the art. In a preferred embodiment of the present invention, the glue is high penetration hot melt glue. The container is useful for shipping iced perishables including fowl, fish, meats, vegetables and fruit. The container includes a bottom panel FIG. 14 having an upwardly facing inner surface and a downwardly facing outer surface. A pair of side panels that extend upwardly from opposite sides of the bottom panel and include inwardly facing inner surfaces, and outwardly facing outer surfaces. A pair of end panels extend upwardly from opposite sides of the bottom panel adjacent the side panels. The end panels likewise include inwardly facing inner surfaces and outwardly facing outer surfaces. A top may be constructed of the board of FIG. 13 to include short depending walls, which fittingly receive the upper ends of the panels.

In a preferred embodiment, the corrugated medium is treated with a wax-free and liquid wicking and penetration resistant medium. Preferably, the corrugated medium is treated with a polymeric material and/or papermaking-sizing agents to make it water-resistant and humidity-resistant. The treatment of the corrugated medium is vital because the boxboards have open edges that are exposed to ambient conditions. Such open edges are weak spot for liquids and humidity to invade the boxboard, thereby diminishing the performance of the boxboard container. Preferred polymeric material which may be used include but are not limited to: Spectra-Guard® 763-AGH, Spectra-Guard® 763B, Spectra-Shield® 44, and Spectra-Guard® 3000, manufactured by Spectra-Kote® Corporation, Fourth and East Water Street, Gettysburg, Pa.; EvCote® CMA-100, manufactured by EvCo Research, Inc. 244 John B. Brooks Road, Pendergrass, Ga.; FIBREMAX® 105B, manufacture by Michelman Inc. 9080 Shell Road, Cincinnati, Ohio; and FIBRESHIELD® 283, 350, 409 and 454, manufactured by International Paper Company, Industrial Packaging Division, Memphis, Tenn. Typical sizing agents which may be used to render the corrugated medium resistant to water/humidity include but are not limited to: Spectra-Guard® 763B; alkyl ketene dimer emulsion (AKD), preferably HERCON® manufactured by Hercules Incorporated, 1313 North Market Street, Wilmington, Del.; alkenyl succinic anhydride (ASA), preferably AKD DP32A, manufactured by Eka Chemicals Inc., 1775 West Oak Commons Court, Marietta, Ga.; ACCISUZE® 18, manufactured by Albemarle Corporation 451 Florida Street, Baton Rouge La.; and rosin products, preferably XR-4177, manufactured by Arizona Chemical Company, 1001 E. Business Hwy 98, Panama City, Fla. Various starches can be used in addition to the polymeric materials and sizing agents to assist with the performance of the medium. Treatment on the medium can be performed on the papermachine at the size press and/or in the wet end. The medium can also be off-machine coated using rod, blade, air knife, curtain or other coating configurations.

In another preferred embodiment, the linerboards may be whitetop liner or whitetop linerboard. The coating may be applied on the inner and/or outer surfaces of the first and/or second linerboard. Preferable chemicals used to coat the linerboard are Spectra-Guard® 763-AGH, Spectra-Guard® 763B, Spectra-Shield® 44, and Spectra-Guard® 3000, manufactured by Spectra-Kote® Corporation, Fourth and East Water Street, Gettysburg, Pa.; EvCote® CMA-100, manufactured by EvCo Research, Inc. 244 John B. Brooks Road, Pendergrass, Ga.; FIBREMAX® 105B, manufacture by Michelman Inc. 9080 Shell Road, Cincinnati, Ohio; and FIBRESHIELD® 283, 350, 409 and 454, manufactured by International Paper Company, Industrial Packaging Division, Memphis, Tenn. FIGS. 2-11 show the various constructions of the coating on the liner of the corrugated boxboard. The constructions used vary according to the goods being carried and the degree of water/humidity resistance they require.

TABLE I
Water/humidity resistant chemical treatment trial
on 33 lb/msf basis weight medium

| | a | b | c | d | e | f |
|---|---|---|---|---|---|---|
| Wicking | 9/16 | 3/16 | 3/16 | 3/16 | >1.5 | 2/16 |
| Measurement | | | | | | |
| 1 inch | | | | | | |
| Wicking | 1 & | 2/16 | 3/16 | 3/16 | >1.5 | 2/16 |
| Measurement | 3/32 | | | | | |
| 1 inch | | | | | | |

a: without addition of any chemical treatment in this invention (control, pre-trial)
b: added 90# Spectra-Guard 763B/ton at the size press
c: added 45# Spectra-Guard 763B + 50# starch/ton at the size press
d: added 4.5# AKD/ton at the wet end
e: without addition of any chemical treatment in this invention (control, post trial)
f: commercial wax impregnated 33# medium from Mosinee (a paper company in Wisconsin) as the benchmark standard

Corrugated medium coated strips were set up along the machine direction hanging above a reservoir of water with the bottom edges of the strips dripped in water for ⅛ of an inch. Four to six 1-inch strips were set up for each condition, and the watermarks were read after 24 hours. Table 1 shows that the treated corrugated medium coated strips of the present invention performed as well as the wax impregnated strips.

In a preferred embodiment a blank for a poultry box, (body and lid,) can be fabricated from the boxboard sheets of this invention shown in FIGS. 13 and 14. Boxes are erected from the blanks. A preferred configuration of the constructed box, body blank or lid blank comprises securing the box or blank panels with a high penetration hot melt glue. The preferred hot melt glue are SWK 1043 manufactured by SWK Enterprises, Inc., 1785 Burlington Road, Bridgeton, N.J. 08302, Upaco 9204-2 available from Worthen Industries, Upaco Coating Division, 3 E. Spit Brook Road, Nashua, N.H. 03060, and H1578 available from Bostik Findley, Inc. 11320 Watertown Plank Road, Wauwatosa, Wis.

It will be appreciated that the use of the corrugated board of the present invention in erecting boxes containing linerboards and corrugated medium coated in accordance with the invention improves the repulpability of the box so that containers made from such board may be more readily and more economically recycled than boxes made of conventionally wax coated water-repellant paperboard, and provides a recycled pulp of improved quality.

It has also been observed that a board coated according to the present invention exhibits improved repulpability as compared with water-repellant boards such as wax-coated boards and boards coated with polyethylene resin or extrudable film-forming thermoplastic resins such as polypropylene, as well as polyolefin coatings.

Additionally, board produced in accordance with the present invention exhibits improved resistance to blocking under warm and humid conditions. This generally improves the handling properties of the board in relation to stacking of flattened-out boards or blanks and conveyance of the board through the stages of manufacture, and limits blocking of adjacent boxes in shipment and storage.

The present invention provides advantages over prior practice in providing a paperboard, which can be recycled by conventional methods without any special measures or equipment.

It will be recognized by those skilled in the art that the paperboard of the invention have wide application in the production of packages or containers having water resistance, low slip, hot melt glueability, grease resistance and moisture vapor barrier characteristics.

The foregoing description of various and preferred embodiments of the present invention has been provided for purposes of illustration only, and it is understood that numerous modifications, variations and alterations may be made without departing from the scope and spirit of the invention as set forth in the following claims.

1. A repulpable corrugated board comprising:
(a) a first linerboard having an inner surface and an outer surface
(b) a second linerboard having an inner surface and an outer surface
(c) a corrugated medium sandwiched between the inner surface of the first linerboard and the inner surface of the second linerboard adhered thereto,
wherein the corrugated medium is coated with a wax-free polymeric agent, selected from the group consisting of Spectra-Guard® 763-AGH, Spectra-Guard® 763B, Spectra-Shield® 44, Spectra-Guard® 3000, EvCote® CMA-100, FIBREMAX® 105B, FIBRESHIELD® 283, FIBRESHIELD® 350, Fibreshield® 409 and FIBRESHIELD® 454,
wherein the corrugated board exhibits improved repulpability.

2. The corrugated board of as defined in claim 1, which is useful in fabricating containers for shipping and storing perishables.

3. The corrugated board as defined in claim 2,wherein the perishable is chicken.

4. The corrugated board as defined in claim 2 wherein the container is secured with high penetration hot-melt glue.

5. The corrugated board of claim 1 wherein at least one of said outer or inner surfaces of said first or second linerboard is coated with a wax-free polymeric coating selected from the group consisting of Spectra-Guard® 763-AGH, Spectra-Guard® 763B, Spectra-Shield® 44, Spectra-Guard® 3000, EvCote® CMA-100, FIBREMAX® 105B, FIBRESHIELD® 283, FIBRESHIELD® 350, FIBRESHIELD® 409 and FIBRESHIELD ® 454.

6. The corrugated board as defined in claim 5, which is useful in fabricating containers for shipping and storing perishables.

7. The corrugated board as defined in claim 6, wherein the perishable is chicken.

8. The corrugated board as defined in claim 6 wherein the container is secured with high penetration hot-melt glue.

9. A repulpable corrugated board comprising:
(a) a first linerboard having an inner surface and an outer surface
(b) a second linerboard having an inner surface and an outer surface
(c) a corrugated medium sandwiched between the inner surface of the first linerboard and the inner surface of the second linerboard adhered thereto,
wherein the corrugated medium is coated with a wax-free sizing agent is selected from the group consisting of Spectra-Guard® 763B; alkyl ketene dimer emulsion, alkenyl succinic anhydride and rosin products,
wherein the corrugated board exhibits improved repulpability.

10. The corrugated board as defined in claim 9, wherein the alkyl ketene dimmer emulsion is HERCON®.

11. The corrugated board as defined in claim 9 wherein the alkenyl succinic anhydride is AKD DP32A.

12. The corrugated board as defined in claim 9 wherein the alkenyl succinic anhydride is ACCISUZE® 18.

13. The corrugated board as defined in claim 9 wherein the rosin product is XR 4177.

14. The corrugated board as defined in claim 9, which is useful in fabricating containers for shipping and storing perishables.

15. The corrugated board as defined in claim 14, wherein the perishable is chicken.

16. The corrugated board as defined in claim 14 wherein the container is secured with high penetration hot-melt glue.

17. The corrugated board as defined in claim 9 wherein at least one of said outer or inner surfaces of said first or second linerboard is coated with a wax-free polymeric coating selected from the group consisting of Spectra-Guard® 763-AGH, Spectra-Guard® 763B, Spectra-Shield® 44, Spectra-Guard® 3000, EvCote® CMA-100, FIBREMAX® 105B, FIBRESHIELD® 283, FIBRESHIELD® 350, FIBRESHIELD® 409 and FIBRESHIELD® 454.

18. The corrugated board as defined in claim 17, which is useful in fabricating containers for shipping and storing perishables.

19. The container of claim 18, wherein the perishable is chicken.

20. The corrugated board as defined in claim 18 wherein the container is secured with high penetration hot-melt glue.

21. A repulpable corrugated board comprising:
(a) a first linerboard having an inner surface and an outer surface
(b) a second linerboard having an inner surface and an outer surface
(c) a corrugated medium sandwiched between the inner surface of the first linerboard and the inner surface of the second linerboard adhered thereto,
wherein the corrugated medium is coated with a wax-free polymeric agent selected from the group consisting of Spectra-Guard® 763-AGH, Spectra-Guard® 763B, Spectra-Shield® 44, Spectra-Guard® 3000, EvCote ® CMA-100, FIBREMAX® 105B, FIBRESHIELD® 283, FIBRESHIELD® 350, FIBRESHIELD® 409 and FIBRESHIELD® 454 and a sizing agent is selected from the group consisting of Spectra-Guard® 763B; alkyl ketene dimer emulsion, alkenyl succinic anhydride and rosin products,
wherein the corrugated board exhibits improved repulpability.

22. The corrugated board as defined in claim 21, wherein the alkyl ketene dimmer emulsion is HERCON®.

23. The corrugated board as defined in claim 21, wherein the alkenyl succinic anhydride is AKD DP32A.

24. The corrugated board as defined in claim 21, wherein the alkenyl succinic anhydride is ACCISUZE® 18.

25. The corrugated board as defined in claim 21, wherein the rosin product is XR-4177.

26. The corrugated board as defined in claim 21, which is useful in fabricating containers for shipping and storing perishables.

27. The corrugated board as defined in claim 26, wherein the perishable is chicken.

28. The corrugated board as defined in claim 26 wherein the container is secured with high penetration hot-melt glue.

29. The corrugated board as defined in claim 21, wherein at least one of said outer or inner surfaces of said first or second linerboard is coated with a wax-free polymeric coating selected from the group consisting of Spectra-Guard® 763-AGH, Spectra-Guard® 763B, Spectra-Shield® 44, Spectra-Guard® 3000, EvCote® CMA-100, FIBREMAX® 105B, FIBRESHIELD® 283, FIBRESHIELD® 350, FIBRESHIELD® 409 and FIBRESHIELD® 454.

30. The corrugated board as defined in claim 29, which is useful in fabricating containers for shipping and storing perishables.

31. The corrugated board as defined in claim 30,wherein the perishable is chicken.

32. The corrugated board as defined in claim 30 wherein the container is secured with high penetration hot-melt glue.

33. A corrugated medium useful in fabricating corrugated board wherein said medium is treated with a polymeric agent selected from the group consisting of Spectra-Guard® 763-AGH, Spectra-Guard® 763B, Spectra-Shield® 44, Spectra-Guard® 3000, EvCote® CMA-100, FIBREMAX® 105B, FIBRESHIELD® 283, FIBRESHIELD® 350, FIBRESHIELD® 409 and FIBRESHIELD® 454, wherein the corrugated medium exhibits improved repulpability.

34. The corrugated medium as defined in claim 33, wherein the corrugated board is used for fabricating container for storing and shipping perishables.

35. The corrugated medium as defined in claim 34, wherein the perishable is chicken.

36. The corrugated medium as defined in claim 34 wherein the container is secured with high penetration hot-melt glue.

37. A corrugated medium useful in fabricating corrugated board wherein said medium is treated with a sizing agent selected from the group consisting of Spectra-Guard® 763B; alkyl ketene dimer emulsion, alkenyl succinic anhydride and rosin products,
wherein the corrugated medium exhibits improved repulpability.

38. The corrugated medium as defined in claim 37, wherein the alkyl ketene dimmer emulsion is HERCON®.

39. The corrugated medium as defined in claim 37, wherein the alkenyl succinic anhydride is AKD DP32A.

40. The corrugated medium as defined in claim 37, wherein the alkenyl succinic anhydride is ACCISUZE® 18.

41. The corrugated medium as defined in claim 37, wherein the rosin product is XR-4177.

42. The corrugated medium as defined in claim 37, wherein the corrugated board is used for fabricating container for storing and shipping perishables.

43. The corrugated medium as defined in claim 42, wherein the perishable is chicken.

44. The corrugated medium as defined in claim 42 wherein the container is secured with high penetration hot-melt glue.

45. A corrugated medium useful in fabricating corrugated board wherein said medium is treated with a polymeric agent selected from the group consisting of Spectra-Guard® 763-AGH, Spectra-Guard® 763B, Spectra-Shield® 44, Spectra-Guard® 3000, EvCote® CMA-100, FIBREMAX® 105B, FIBRESHIELD® 283, FIBRESHIELD® 350, FIBRESHIELD® 409 and FIBRESHIELD® 454 and a sizing agent selected from the group consisting of Spectra-Guard® 763B; alkyl ketene dimer emulsion, alkenyl succinic anhydride and rosin products,
wherein the corrugated medium exhibits improved repulpability.

46. The corrugated medium as defined in claim 46, wherein the alkyl ketene dimmer emulsion is HERCON®.

47. The corrugated medium as defined in claim 46, wherein the alkenyl succinic anhydride is AKD DP32A.

48. The corrugated medium as defined in claim 46, wherein the alkenyl succinic anhydride is ACCISUZE® 18.

49. The corrugated medium as defined in claim 46, wherein the rosin product is XR-4177.

50. The corrugated medium as defined in claim 46, wherein the corrugated board is used for fabricating container for storing and shipping perishables.

51. The corrugated medium as defined in claim 50, wherein the perishable is chicken.

52. The corrugated medium as defined in claim 50 wherein the container is secured with high penetration hot-melt glue.
